(19) United States
(12) Patent Application Publication
(10) Pub. No.: US 2025/0148919 A1
(43) Pub. Date: May 8, 2025

(54) MOBILITY SHARING SYSTEM PROVIDING FLEET RELOCATION STRATEGY

(71) Applicant: grovy Inc., Seoul (KR)

(72) Inventors: Misung CHO, Seoul (KR); Byungkwan JUNG, Seoul (KR); Sunwoo JIN, Yongin-si (KR); Youngjin Han, Seoul (KR); Ahyoung SHIN, Goyang-si (KR)

(21) Appl. No.: 18/517,021

(22) Filed: Nov. 22, 2023

(30) Foreign Application Priority Data
Nov. 2, 2023 (KR) 10-2023-0150036

(51) Int. Cl. G08G 1/00; G06N 3/044; G06N 3/088

(52) U.S. Cl. CPC G08G 1/202; G06N 3/044; G06N 3/088

(57) ABSTRACT

The present invention relates to a mobility sharing system that operates a mobility location strategy using a deep learning algorithm. A first vehicle determination unit divides an entire area into a plurality of unit areas and determines the number of vehicles to be located in each of the plurality of unit areas. A prediction unit, by inputting a prediction data set generated based on the number of vehicles departing from each of stations and the number of vehicles arriving at each of the stations into a bidirectional recurrent neural network (RNN) model, predicts the number of vehicles departing from each of the stations and the number of vehicles arriving at each of the stations during a target time interval. A second vehicle determination unit sets the number of location vehicles to be located at each of the stations in the target time interval. A route setting unit applies an MCMF algorithm to the number of location vehicles to be located at each of the stations to determine a mobility location route for placing vehicles at each of the stations.

### CROSS-REFERENCE TO RELATED APPLICATION

This application claims priority to Korean Patent Application No. 10-2023-0150036, filed in the Korean Intellectual Property Office on Nov. 2, 2023, the disclosure of which is incorporated by reference herein in its entirety.

### BACKGROUND OF THE INVENTION

### Field of the Invention

The present invention relates to a mobility sharing system that provides a fleet relocation strategy using a deep learning algorithm.

### Description of the Related Art

Recently, there has been a paradigm shift from an ownership-based economy to a sharing economy, and a representative system that leads this sharing economy is “car sharing” in the field of transportation. A conventional mobility sharing system has mostly a round-trip method, where a user rents a vehicle from a parking lot close to the user's location and returns the vehicle to the same place as the starting point. This has a limitation in that the user has to return the vehicle back to the place where the user rented the vehicle, which causes a lot of inconvenience for the users.

Therefore, recently there has been an increasing demand for a one-way service. However, due to a current structure of the car sharing service, which is operated by registering a vehicle as a regular parking vehicle in a parking lot, the one-way service has a problem of incurring parking costs for unregistered vehicles, and the very high costs of returning vehicles to solve a problem of vehicles being concentrated in a specific area. Therefore, it is necessary to have an efficient mobility location strategy to operate the one-way service.

### SUMMARY OF THE INVENTION

The present invention is directed to providing a mobility sharing system that operates a mobility location strategy using a deep learning algorithm.

A mobility sharing system according to an embodiment of the present invention may include a first vehicle determination unit, a prediction unit, a second vehicle determination unit, and a route setting unit. The first vehicle determination unit may divide an entire area into a plurality of unit areas and determine the number of vehicles to be located in each of the plurality of unit areas. The prediction unit may predict the number of departing vehicles departing from each of stations and the number of arriving vehicles arriving at each of the stations during a target time interval after a plurality of unit time intervals by inputting a prediction data set generated based on the number of departing vehicles departing from each of stations included in a first unit area of a plurality of unit areas and the number of arriving vehicles arriving at each of the stations for each of the plurality of unit time intervals into a bidirectional recurrent neural network (RNN) model. The second vehicle determination unit may set the number of location vehicles to be located at each of the stations in the target time interval based on the predicted number of departing vehicles, the predicted number of arriving vehicles, and a set condition. The route setting unit may determine a mobility location route for locating vehicles at each of the stations by applying a minimum cost maximum flow (MCMF) algorithm to the number of location vehicles to be located at each of the stations.

The mobility sharing system of the present invention can provide an efficient mobility location strategy based on a deep learning algorithm. In the present invention, the speed of the deep learning model can be improved by dividing an entire area targeted for a service into multiple unit intervals and finding a mobility location strategy for each unit interval. In the present invention, the speed of the deep learning model can be increased by reducing a size of the dataset input to the deep learning model by processing raw data. In addition, In the present invention, based on the bidirectional RNN algorithm, the number of vehicles departing from each station and the number of vehicles arriving at each station can be predicted more accurately. In addition, the present invention can provide a mobility location strategy that is capable of satisfying an expected vehicle demand at a low location cost using the MCMF algorithm.

### BRIEF DESCRIPTION OF THE DRAWINGS

FIG. 1 is a block diagram for describing a mobility sharing system of the present invention.

FIG. 2 is a conceptual view for describing a clustering method of a first vehicle determination unit.

FIG. 3 is a conceptual view for describing a prediction data set used in a prediction unit.

FIG. 4 is a conceptual view for describing a bidirectional RNN model used in the prediction unit.

FIG. 5 is a conceptual view for describing an MCMF algorithm used in a route setting unit.

FIG. 6 is a block diagram for describing an embodiment of the mobility sharing system of the present invention.

### DETAILED DESCRIPTION OF THE INVENTION

The present invention may be variously modified and may have various embodiments, and particular embodiments illustrated in the drawings will be described in detail below. However, the description of the embodiments is not intended to limit the present invention to the particular embodiments, but it should be understood that the present invention is to cover all modifications, equivalents and alternatives falling within the spirit and technical scope of the present invention.

The terms such as “first” and “second” may be used to describe various constituent elements, but the constituent elements should not be limited by the terms. These terms are used only to distinguish one constituent element from another constituent element. For example, a first constituent element may be named a second constituent element, and similarly, the second constituent element may also be named the first constituent element, without departing from the scope of the present invention. The term “and/or” includes any and all combinations of a plurality of the related and listed items.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

The terminology used in the present application is used for the purpose of describing particular embodiments only and is not intended to limit the present invention. Singular expressions include plural expressions unless clearly described as different meanings in the context. In the present application, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

In this regard, such as “about”, “substantially”, and the like are used throughout the specification of the present application in the sense of “at, or nearly at, when given the manufacturing, design, and material tolerances inherent in the stated circumstances” and are used to prevent the unscrupulous infringer from unfairly taking advantage of the present disclosure where exact or absolute figures and operational or structural relationships are stated as an aid to understanding the present invention. Throughout the specification of the present invention, the term “step . . . ” or “step of . . . ” does not mean “step for . . . ”.

In the present specification, the term ‘unit’ includes a unit realized by hardware, a unit realized by software, and a unit realized by using both software and hardware. In addition, one unit may be realized by using two or more hardware, and two or more units may be realized by using one hardware.

In the present specification, some of the operations or functions, which are described as being performed by a terminal, an apparatus, or a device, may be instead performed by a server connected to the terminal, the apparatus, or the device. Likewise, some of the operations or functions, which are described as being performed by a server, may be performed by a terminal, an apparatus, or a device that is connected to the server.

Unless otherwise defined, all terms used herein, including technical or scientific terms, have the same meaning as commonly understood by those skilled in the art to which the present invention pertains. The terms such as those defined in a commonly used dictionary should be interpreted as having meanings consistent with meanings in the context of related technologies and should not be interpreted as ideal or excessively formal meanings unless explicitly defined in the present application.

Hereinafter, an exemplary embodiment of the present invention will be described in detail with reference to the accompanying drawings. In describing the present invention, the same reference numerals are used for identical constituent elements in the drawings, and redundant descriptions of identical constituent elements are omitted in order to facilitate an overall understanding.

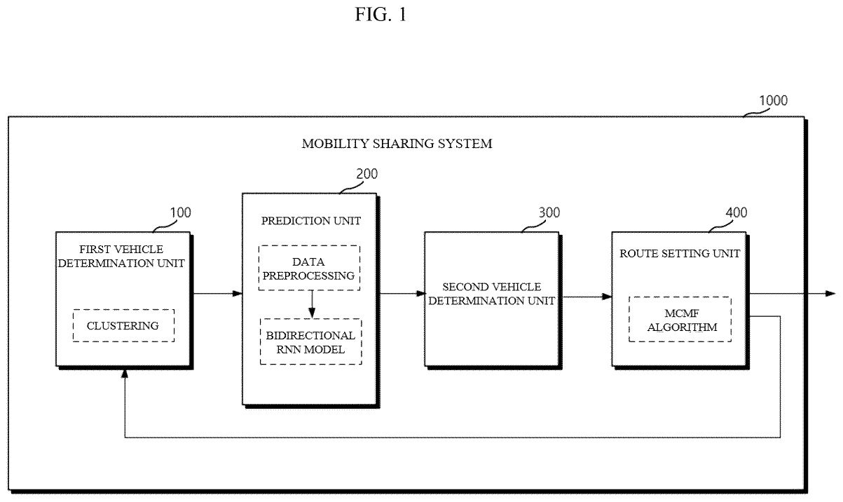

(Embodiment 1) To describe Embodiment 1, FIG. 1 is referenced herewith. A mobility sharing system 1000 of the present invention includes a first vehicle determination unit 100, a prediction unit 200, a second vehicle determination unit 300, and a route setting unit 400. The mobility sharing system 1000 may not include all of the constituent elements 100 to 400 illustrated in FIG. 1, and may further include constituent elements not illustrated (e.g., a processor, a memory, etc.). The mobility sharing system 1000 may be implemented as one of a smartphone, a smartpad, a tablet PC, a notebook with a web browser, a desktop, a laptop, or the like. In addition, the mobility sharing system 1000 may be a cloud-based application that implements the operations and functions of the constituent elements 100 to 400 through a cloud server. In the present disclosure, the mobility sharing system 1000 is described as performing an operation and function for relocating a vehicle, but the mobility sharing system 1000 may perform an operation and function for relocating not only a vehicle but also any fleet, such as a bicycle, a scooter, and the like.

The first vehicle determination unit 100 may divide an entire area that is targeted for service by the mobility sharing system 1000 into a plurality of unit areas. The first vehicle determination unit 100 may determine the number of vehicles to be located in each of the plurality of unit areas. The mobility sharing system 1000 may find a location strategy for locating a vehicle in each of the plurality of unit areas using the remaining constituent elements 200, 300, and 400, respectively. Finding a location strategy to locate vehicles in a unit area may reduce data volume that needs to be processed by the deep learning model, compared to finding a location strategy to locate vehicles in the entire area at once. That is, the mobility sharing system 1000 of the present invention may prevent the deep learning model from being overloaded and improve the speed of the deep learning model.

The prediction unit 200 may predict the number of departing vehicles departing from each of the stations and the number of arriving vehicles arriving at each of the stations during a target time interval using a bidirectional recurrent neural network (RNN) model. In the present invention, based on the bidirectional RNN algorithm, the number of vehicles departing from each station and the number of vehicles arriving at each station during the target time interval may be predicted more accurately. Hereinafter, a method of predicting a mobility location of stations included in a first unit area among a plurality of unit areas is described. Mobility location of the remaining unit areas may be predicted in the same method as the mobility location of the first unit area.

The prediction unit 200 may generate a prediction data set based on the number of vehicles departing from each of stations included in the first unit area and the number of vehicles arriving at each of the stations for each of a plurality of unit time intervals. The prediction data set means data that is input to the bidirectional RNN model. The plurality of unit time intervals corresponds to time intervals preceding the target time interval. That is, the plurality of unit time intervals corresponds to time intervals in the past relative to the target time interval. The prediction unit 200 may predict the number of vehicles departing from each of the stations and the number of vehicles arriving at each of the stations during the target time interval by inputting the prediction data set to the bidirectional RNN model. The mobility sharing system 1000 of the present invention is a system for providing a one-way vehicle sharing service in addition to a conventional two-way vehicle sharing service. Therefore, the prediction data set used in the present invention may be a dataset extracted from a one-way reservation history with different departure and arrival stations.

The second vehicle determination unit 300 may determine the number of location vehicles to be located at each of the stations in the target time interval based on the predicted number of departing vehicles, the predicted number of arriving vehicles, and a preset condition.

The route setting unit 400 may determine a mobility location route for locating vehicles at each of the stations by applying a minimum cost maximum flow (MCMF) algorithm to the number of location vehicles to be located at each of the stations. The present invention may provide a mobility location strategy that is capable of satisfying an expected vehicle demand at a low location cost using the MCMF algorithm.

A memory (not shown) may store instructions for operating each component 100 to 400 as well as information about the bidirectional RNN model and reservation history. Memory may include non-volatile memory, volatile memory that may be accessed at any time, and/or various other types of memory. For example, it may include flash memory, DRAM, PRAM, or a combination thereof.

A processor (not shown) may operate each component 100 to 400 by executing instructions stored in memory. Additionally, the processor may train the prediction unit 200 according to user settings.

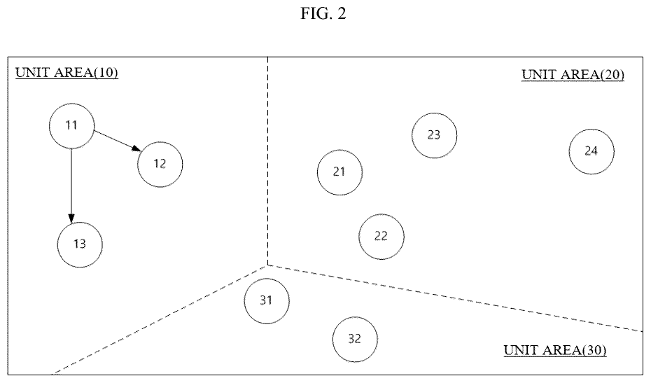

(Embodiment 2) To describe Embodiment 2, FIG. 1 and FIG. 2 are referenced herewith. The first vehicle determination unit 100 may divide the entire area that is targeted for service by the mobility sharing system 1000 into a plurality of unit areas. The first vehicle determination unit 100 may divide the entire area into the plurality of unit areas based on historical data. The first vehicle determination unit 100 may generate the historical data by extracting specific information from reservation history received on the mobility sharing system 1000 in the past. The historical data may include at least one of a service reservation time, a departure time, an arrival time, a departure station of a vehicle, an arrival station of a vehicle, a cost, and positions of the stations. The mobility sharing system 1000 of the present invention is a system for providing a one-way vehicle sharing service in addition to the conventional two-way vehicle sharing service. Therefore, the historical data used in the present invention may be data extracted from a one-way reservation history with different departure and arrival stations.

The first vehicle determination unit 100 may divide the entire area into the plurality of unit areas using a clustering model based on unsupervised learning. For example, the clustering model may be implemented as one of a K-means clustering algorithm, a K-medians clustering algorithm, a mean-shift clustering algorithm, or a density-based spatial clustering of applications with noise algorithm (DBSCAN algorithm), but is not limited thereto.

(Embodiment 2-1) The first vehicle determination unit 100 may obtain a plurality of unit areas by inputting the historical data into the clustering model. The first vehicle determination unit 100 may set the plurality of unit areas according to the user's intention by selecting the information included in the historical data. In this case, the plurality of unit areas may be set such that there is a high probability that a departure station and an arrival station of a vehicle using a one-way service are included in the same unit area.

(Embodiment 2-2) As another example, the first vehicle determination unit 100 may generate the historical data such that the historical data include information on the locations and costs of the stations. In this case, the first vehicle determination unit 100 may set the plurality of unit areas such that a sum of a station cost for each of all stations included in the entire area is minimized. The station cost is proportional to a sum of squares of distances from one station included to the remaining stations included in a unit area containing the station. With reference to FIG. 2, a cost of a station 11 is proportional to a sum of distances from the station 11 to the remaining stations 12 and 13. The station 11 represents an arbitrary station belonging to a unit area 10, and the stations 12 and 13 represent the remaining stations belonging to a unit area 10. The first vehicle determination unit 100 may divide the unit areas such that a sum of costs of the stations 11 to 32 is minimized.

(Embodiment 2-3) As another example, the first vehicle determination unit 100 may set the plurality of unit areas such that a sum of absolute values of area differences between the plurality of unit areas is minimized. With reference to FIG. 2, the first vehicle determination unit 100 may divide the unit areas such that a sum of an absolute value of an area difference between the unit area 10 and the unit area 20, an absolute value of an area difference between the unit area 20 and the unit area 30, and an absolute value of an area difference between the unit area 10 and the unit area 30 is minimized.

(Embodiment 2-4) As another example, the first vehicle determination unit 100 may set the plurality of unit areas such that a station closest to one station among all stations is included in the same unit area in which the one station is included. With reference to FIG. 2, when a station closest to the station 11 is the station 12, the first vehicle determination unit 100 may set the plurality of unit areas such that the station 11 and the station 12 are included in the same unit area.

Although the first vehicle determination unit 100 has been described as setting the plurality of unit areas based on the deep learning model, the present invention is not limited thereto. The first vehicle determination unit 100 may set the plurality of unit areas by a preset algorithm.

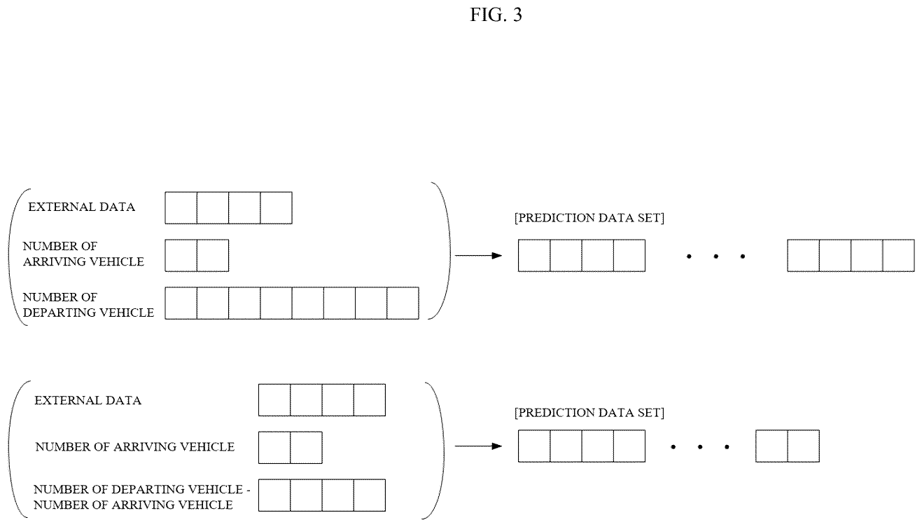

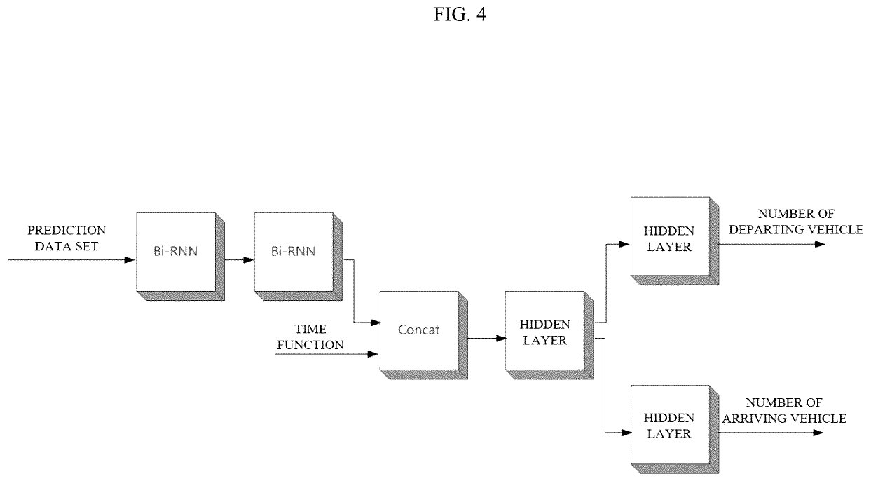

(Embodiment 3) To describe Embodiment 3, FIG. 1, FIG. 3, and FIG. 4 are referenced herewith. The prediction unit 200 may predict the number of departing vehicles departing from each of the stations and the number of arriving vehicles arriving at each of the stations during a target time interval using a bidirectional recurrent neural network (RNN) model. For example, the bidirectional RNN model may be configured with a bidirectional long short-term memory (Bi-LSTM) or a bidirectional gated recurrent unit (Bi-GRU), but is not limited thereto.

The bidirectional RNN adds (1) an RNN layer that performs processing in a reverse direction to an existing RNN layer. A final hidden state outputs a vector concatenating hidden states of the two RNN layers. In addition to concatenation, various methods such as (2) addition and (3) averaging may be applied. The bidirectional RNN model is effective at extracting patterns from long sequences and has higher accuracy by referencing information from both directions. In particular, the bidirectional RNN model is used to predict a future by receiving past time series data as input. Therefore, the prediction unit 200 may predict more accurately a vehicle demand for the target time interval using the bidirectional RNN model. The vehicle demand means the number of departing vehicles departing from each of the stations and the number of arriving vehicles arriving at each of the stations. The prediction unit 200 may use the bidirectional RNN model, which consists of at least two stacked layers of the RNN algorithm. Therefore, the bidirectional RNN model of the present invention can have a high learning capability.

In the present invention, based on a bidirectional RNN model, the number of vehicles departing from each station and the number of vehicles arriving at each station during the target time interval may be predicted more accurately. Hereinafter, a method of predicting a mobility location of stations included in a first unit area among a plurality of unit areas is described. Mobility location of the remaining unit areas may be predicted in substantially the same method as the mobility location of the first unit area.

The prediction unit 200 may generate a prediction data set based on the number of vehicles departing from each of stations included in the first unit area and the number of vehicles arriving at each of the stations for each of a plurality of unit time intervals. The prediction data set means data that is input to the bidirectional RNN model. The plurality of unit time intervals corresponds to time intervals in the past relative to the target time interval. The prediction unit 200 may predict the number of vehicles departing from each of the stations and the number of vehicles arriving at each of the stations during the target time interval by inputting the prediction data set to the bidirectional RNN model.

(Embodiment 3-1) First, the learning and testing operations of the prediction unit 200 are described. The prediction unit 200 may be operated by control of the processor, but is not limited to this, and the prediction unit 200 may be operated by an external sever and/or processor of the mobility sharing system 1000. The mobility sharing system 1000 may train the bidirectional RNN model. The mobility sharing system 1000 may generate a dataset for training by labeling the prediction data set, which includes the number of vehicles departing from each of the stations and the number of vehicles arriving at each of the stations during a plurality of unit time intervals, with correct answer data, which includes the number of vehicles departing from each of the stations and the number of vehicles arriving at each of the stations during the target time interval. The plurality of unit time intervals are time intervals in the past relative to the target time interval. The mobility sharing system 1000 may train the bidirectional RNN model by inputting the dataset for training to the bidirectional RNN model.

During test operations, the prediction data set may be input into the bidirectional RNN model. The prediction unit 200 may predict the number of vehicles departing from each station and the number of vehicles arriving at each station in the target time section based on the prediction data set.

Depending on the extent to which the value predicted by the prediction unit 200 matches the value of the preset correct answer data, the prediction unit 200 may resume or stop learning. In the present invention, in order to increase the efficiency of learning and testing operations, the prediction unit 200 stops the learning operation when the correct answer rate of the output data exceeds 50% in the test stage, excluding the upper 20% and lower 20% of the error range. The correct answer rate means to what extent the predicted value of the output data matches the predicted value of the correct answer data.

(Embodiment 3-2) The prediction data set may be generated based on history data and external data. The prediction unit 200 may extract the history data and external data from reservation records received in the past by the mobility sharing system 1000. The history data may include information regarding the number of vehicles departing from each of the stations, the number of vehicles arriving at each of the stations, a time of use of a vehicle, a price charged, and the like, for each unit time interval, included in the first unit area. The external data may include information regarding a date when the history data was received, a weather event on the corresponding date, whether the corresponding date is a holiday, competitor pricing during the same time period, and the like.

The prediction unit 200 may generate the prediction data set by embedding the history data and external data. The prediction data set may include information regarding the number of vehicles departing from each of the stations and the number of vehicles arriving at each of the stations included in the first unit area for each unit time interval.

(Embodiment 3-3) To describe Embodiment 3-3, FIG. 1 and FIG. 3 are referenced herewith. The prediction unit 200 may process at least one of the history data or the external data to generate the prediction data set in order to reduce a size of the prediction data set. For example, the prediction unit 200 may generate the prediction data set by embedding a result value of subtracting the number of vehicles departing from each of the stations from the number of vehicles arriving at each of the stations. The number of bits required to represent the result value is equal to or less than the number of bits required to represent the number of vehicles arriving at each of the stations. In this case, instead of including all information regarding the number of vehicles departing from each of the stations and the number of vehicles arriving at each of the stations, the prediction data set may be generated to include information regarding the result value and the number of vehicles departing to each of the stations, or to include information regarding the result value and the number of vehicles arriving at each of the stations.

(Embodiment 3-4) The prediction unit 200 may combine a time function with the prediction data set and input the combined time function with the prediction data set into the bidirectional RNN model. The time function that is combined with the prediction data set may be proportional to sin (2πi/T) or cos (2πi/T). T is a period of the plurality of unit time intervals, and i is an order of a unit time interval corresponding to the prediction data set among the unit time intervals included in the period. For example, each of the plurality of unit time intervals may be set to one hour and the T may be set to 24. As another example, each of the plurality of unit time intervals may be set to one day and the T may be set to 7.

(Embodiment 3-5) To describe Embodiment 3-5, FIG. 1 and FIG. 4 are referenced herewith. The prediction data set combined with the time function is input to the bidirectional RNN model, which may go through a plurality of Bi-RNN layers, a fully connected layer, batch normalization, a dropout, etc. The prediction unit 200 may predict the number of vehicles departing from each of the stations and the number of vehicles arriving at each of the stations in the target time interval by inputting the prediction data set combined with the time function into the bidirectional RNN model.

(Embodiment 4) The second vehicle determination unit 300 may determine the number of vehicles to be located at each of the stations in the target time interval based on the predicted number of departing vehicles, the predicted number of arriving vehicles, and a preset condition. The second vehicle determination unit 300 may prioritize distributing a vehicle to a station having a larger prediction result value of subtracting the predicted number of departing vehicles from the predicted number of arriving vehicles among stations satisfying the set condition. The set condition is a condition that is preset by a user, and may be a complaint occurrence due to a lack of vehicles, a full of vehicles, an inclusion of an electric vehicle charging station, or the like.

(Embodiment 4-1) As mentioned above, the second vehicle determination unit 300 may prioritize distributing a vehicle to a station that satisfies the preset condition and has a larger prediction result value of subtracting the predicted number of departing vehicles from the predicted number of arriving vehicles. Additionally, when the stations have the same prediction result value, the second vehicle determination unit 300 may prioritize distributing a vehicle to a station having a larger sum of the predicted number of departing vehicles and the predicted number of arriving vehicles. The station having a larger sum of the predicted number of departing vehicles and the predicted number of arriving vehicles is more likely to have a large number of moving vehicles and a high user's demand compared to a station having a smaller sum of the predicted number of departing vehicles and the predicted number of arriving vehicles. Therefore, when the vehicles are distributed according to the order described above, the vehicles may be distributed to a station with a higher importance first.

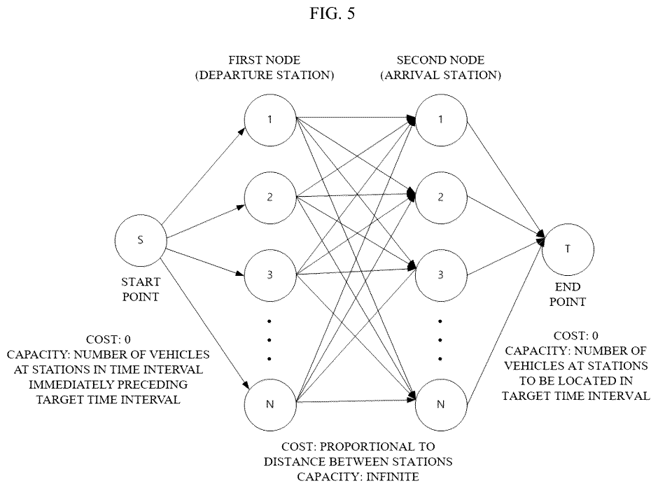

(Embodiment 6) To describe Embodiment 6, FIG. 5 is referenced herewith. The route setting unit 400 may determine a mobility location route for locating vehicles at each of the stations by applying the minimum cost maximum flow (MCMF) algorithm to the number of location vehicles to be located at each of the stations. The MCMF algorithm is an algorithm used to find a route with a maximum flow at a minimum cost. The route setting unit 400 may obtain a route to perform a desired mobility location at a minimum cost by using the MCMF algorithm. The route setting unit 400 may configure the MCMF algorithm with a start point, first nodes corresponding to each of the stations, an end point, and second nodes corresponding to each of the stations. The first and second nodes each have the same level. The first nodes may be connected to the start point, and the second nodes may be connected to the end point. The first nodes may be connected to the second nodes. The route setting unit 400 may set a cost between the start point and the first nodes to be zero and a capacity to be proportional to the number of location vehicles of stations corresponding to the first nodes in a time interval immediately preceding the target time interval. The route setting unit 400 may set a capacity between the first and second nodes to be infinite and a cost to be proportional to distances between stations corresponding to the first nodes and stations corresponding to the second nodes. The route setting unit 400 may set a cost between the second nodes and the end point to be zero and a capacity to be proportional to the number of location vehicles of the stations corresponding to the second nodes in the target time interval. The route setting unit 400 may obtain a mobility location route for locating vehicles at each of the stations by the number of vehicles determined by the second vehicle determination unit 300 using the MCMF algorithm created with the settings described above.

(Embodiment 6-1) The route setting unit 400 may set the cost between the first and second nodes such that a large number of vehicle movements occur at a station having a higher importance. The station having a higher importance means a station with a large number of departing and arriving vehicles. The route setting unit 400 may set the cost between the first and second nodes to be proportional to a distance and inversely proportional to at least one of the number of location vehicles of the stations corresponding to the first nodes in the target time interval and the number of location vehicles of the stations corresponding to the second nodes in the target time interval. In this case, the station with a large number of departing and arriving vehicles has a higher probability of being used as the mobility location route.

(Embodiment 6-2) Depending on a mobility location cost required to follow finally determined mobility location routes, the route setting unit 400 may set only a part of the finalized mobility location routes to be valid. When a finally determined mobility location cost does not exceed a preset value, the route setting unit 400 may set all of the finally determined mobility location routes to be valid. In this case, the vehicles may be located at all the stations along the finally determined mobility location routes. When the finally determined mobility location cost exceeds the preset value, the route setting unit 400 may set only a part of the finally determined mobility location routes to be valid. In this case, the vehicles may be located at the stations only along the valid route of the finally determined mobility location routes. A route that is set to invalid is not used to relocate a vehicle.

(Embodiment 6-3) When the finally determined mobility location cost exceeds the preset value, the route setting unit 400 may set only a part of the finally determined mobility location routes to be valid according to a specific condition. The specific condition may be to locate a vehicle first in an order of important stations, and not to locate a vehicle to unimportant stations, or to first select a vehicle movement between stations with lower costs, and not to select a vehicle movement between stations with higher costs. The cost between the stations may be proportional to the distance between the stations.

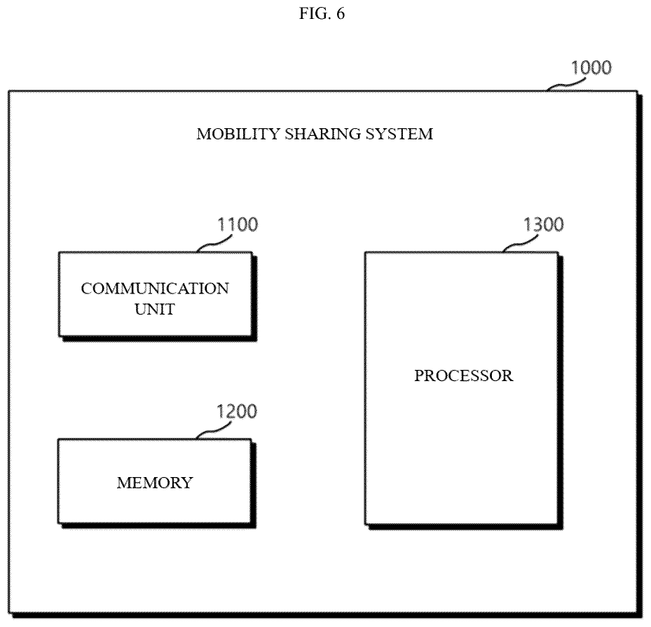

FIG. 6 is a block diagram illustrating a configuration of a mobility sharing system according to an embodiment of the present invention.

The mobility sharing system illustrated in FIG. 6 may perform substantially the same operations as the mobility sharing system 1000 in FIG. 1. The mobility sharing system 1000 may include a communication unit 1100, a memory 1200, and a processor 1300. The mobility sharing system 1000 may be implemented as an embedded board, a smartphone, a tablet PC, a PC, a smart TV, a cell phone, a personal digital assistant (PDA), a laptop, a vehicle, and other mobile or non-mobile computing devices, but is not limited thereto.

The communication unit 1100 may include one or more constituent elements that enable the mobility sharing system 1000 to communicate with an external electronic device. The communication unit 1100 may include a short-range wireless communication unit (not illustrated), a mobile communication unit (not illustrated), and a broadcast reception unit (not illustrated). The short-range wireless communication unit may include a Bluetooth communication unit, a Bluetooth low energy (BLE) communication unit, a near field communication unit, a WLAN (Wi-Fi) communication unit, a Zigbee communication unit, an infrared data association (IrDA) communication unit, a Wi-Fi Direct (WFD) communication unit, an ultra wideband (UWB) communication unit, an Ant+ communication unit, and the like, but is not limited thereto. The mobile communication unit transmits and receives a wireless signal to and from at least one of a base station, an external terminal, or a server in a mobile communication network. Here, the wireless signal may include a voice call signal, a video call signal, or various forms of data according to transmission or reception of text/multimedia messages. The broadcast reception unit receives a broadcast signal and/or information related to broadcasting from an external source through a broadcast channel. The broadcast channel may include a satellite channel or a terrestrial channel. Depending on an implementation example, the communication unit 1100 may not include the broadcast reception unit. The mobility sharing system 1000 may also receive order logs for existing items, attribute information on the existing items, and attribute information on new items from an external device through the communication unit 1100.

The memory 1200 may store a program for processing and controlling the processor 1300, and may store data that is input to the mobility sharing system 1000 or output from the mobility sharing system 1000. In addition, the memory 1200 may store algorithms for implementing the clustering model, the bidirectional RNN model, and the MCMF model used in the mobility sharing system 1000. In addition, the memory 1200 may store the order logs for the existing items, the attribute information on the existing items, and the attribute information on the new items.

The memory 1200 may include at least one type of storage medium among a flash memory type, a hard disk type, a multimedia card micro type, a card type of memory (e.g., SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk.

The processor 1300 may generally control an overall operation of the mobility sharing system 1000. The processor 1300 may perform the operations of the mobility sharing system 100 described with reference to FIGS. 1 to 5, and provide services provided by the mobility sharing system 100, by executing the programs stored in the memory 1200. The processor 1300 may be implemented as a central processing unit (CPU), or a processing unit optimized for operating a machine learning model, such as a graphic processing unit (GPU), a neural processing unit (NPU), or the like. The processor 1300 may implement the machine learning and deep learning-based model described with reference to FIG. 1 using a language such as Java, C/C++, python, or R, and an implementation language such as TensorFlow, Keras, or Pytorch based on python.

The descriptions above are specific embodiments for carrying out the present invention. The present invention includes not only the embodiments described above, but also embodiments that can be simply modified in design or easily modified. In addition, the present invention includes technologies that can be easily modified and carried out using the embodiments. Therefore, the scope of the present invention should not be limited to the described embodiments, and should be defined by not only the claims to be described below, but also those equivalents to the claims.

What is claimed is:

1. A mobility sharing system comprising:
a first vehicle determination unit configured to divide an entire area into a plurality of unit areas, and to determine the number of vehicles to be located in each of the plurality of unit areas;
a prediction unit configured to, by inputting a prediction data set generated based on the number of vehicles departing from each of stations included in a first unit area of the plurality of unit areas for each of a plurality of unit time intervals and the number of vehicles arriving at each of the stations into a bidirectional recurrent neural network (RNN) model, predict the number of vehicles departing from each of the stations and the number of vehicles arriving at each of the stations during a target time interval after the plurality of unit time intervals;
a second vehicle determination unit configured to, based on the predicted number of departing vehicles, the predicted number of arriving vehicles, and a set condition, set the number of location vehicles to be located at each of the stations during the target time interval;
a route setting unit configured to determine a mobility location route to locate the vehicles at each of the stations, by applying a minimum cost maximum flow (MCMF) algorithm to the number of location vehicles to be located at each of the stations;
a memory configured to store instructions to operate the prediction unit; and
a processor configured to execute the instructions to operate the prediction.

2. The mobility sharing system of claim 1, wherein the first vehicle determination unit sets the plurality of unit areas using a clustering model that is an unsupervised learning model.

3. The mobility sharing system of claim 1, wherein the first vehicle determination unit sets the plurality of unit areas such that, based on historical data, there is a high probability that a departure station and an arrival station of a vehicle using a one-way service are included in the same unit area.

4. The mobility sharing system of claim 1, wherein the first vehicle determination unit sets the plurality of unit areas such that a sum of station costs of each of all stations included in the entire area is minimized, and
wherein the station costs are proportional to a sum of a square of distances from one station included in one unit area to the remaining stations included in the one unit area.

5. The mobility sharing system of claim 1, wherein the first vehicle determination unit sets the plurality of unit areas such that a sum of absolute values of area differences between the plurality of unit areas is minimized.

6. The mobility sharing system of claim 1, wherein the first vehicle determination unit sets the plurality of unit areas such that a station closest to one station included in the entire area is included in the same unit area with the one station.

7. The mobility sharing system of claim 1, wherein the bidirectional RNN model is configured with a bidirectional gated recurrent unit (Bi-GRU).

8. The mobility sharing system of claim 1, wherein the bidirectional RNN model is configured with a bidirectional long short-term memory (Bi-LSTM).

9. The mobility sharing system of claim 1, wherein the bidirectional RNN model consists of at least two stacked layers of RNN algorithm.

10. The mobility sharing system of claim 1, wherein the prediction unit combines a time function with the prediction data set to input the combined time function with the prediction data set into the bidirectional RNN model,
wherein the time function being combined with the prediction data set is proportional to sin (2πi/T) or cos (2πi/T),
wherein T is a period of the plurality of unit time intervals, and i is an order of the unit time intervals corresponding to the prediction data set among the unit time intervals included in the period.

11. The mobility sharing system of claim 10, wherein each of the plurality of unit time intervals corresponds to one hour, and the T corresponds to 24 hours.

12. The mobility sharing system of claim 10, wherein each of the plurality of unit time intervals corresponds to one day, and the T corresponds to seven days.

13. The mobility sharing system of claim 1, wherein the prediction unit generates the prediction data set by embedding a result value of subtracting the number of vehicles arriving at each of the stations from the number of vehicles departing from each of the stations, and
wherein the number of bits required to represent the result value is equal to or less than the number of bits required to represent the number of vehicles arriving at each of the stations.

14. The mobility sharing system of claim 13, wherein the prediction unit generates the prediction data set such that the prediction data set represents the result value and the number of vehicles departing from each of the stations.

15. The mobility sharing system of claim 13, wherein the prediction unit generates the prediction data set such that the prediction data set represents the result value and the number of vehicles arriving at each of the stations.

16. The mobility sharing system of claim 1, wherein the second vehicle determination unit prioritizes distributing a vehicle to a station having a larger predicted result value of subtracting the predicted number of arriving vehicles from the predicted number of departing vehicles among the stations satisfying the set condition, and
wherein the set condition is a complaint occurrence due to a lack of vehicles, a full of vehicles, or an inclusion of an electric vehicle charging station.

17. The mobility sharing system of claim 1, wherein the second vehicle determination unit prioritizes distributing a vehicle to a station having a larger predicted result value of subtracting the predicted number of arriving vehicles from the predicted number of departing vehicles, and, among stations having the same predicted result value, prioritizes distributing a vehicle to a station having a larger sum of the predicted number of departing vehicles and the predicted number of arriving vehicles.

18. The mobility sharing system of claim 1, wherein the route setting unit configures the MCMF algorithm with a start point, first nodes connected to the start point and corresponding to the stations, an end point, second nodes connected to the end point and corresponding to the stations,
wherein the route setting unit sets a cost between the start point and the first nodes to be zero and a capacity to be proportional to the number of location vehicles of stations corresponding to the first nodes in a time interval immediately preceding the target time interval,
wherein the route setting unit sets a capacity between the first nodes and the second nodes to be infinite and a cost to be proportional to distances between the stations corresponding to the first nodes and the stations corresponding to the second nodes, and
wherein the route setting unit sets a cost between the second nodes and the end point to be zero and a capacity to be proportional to the number of location vehicles at stations corresponding to the second nodes in the target time interval.

19. The mobility sharing system of claim 18, wherein the route setting unit sets a cost between the first and second nodes to be proportional to the distance, and inversely proportional to at least one of the number of location vehicles of the stations corresponding to the first node in the target time interval and the number of location vehicles of the stations corresponding to the second nodes in the target time interval.
